(19) United States
(12) Patent Application Publication
(10) Pub. No.: US 2003/0115329 A1
(43) Pub. Date: Jun. 19, 2003

(54) Stacked approach to service provider Architecture

(76) Inventors: Pascal Joly, Paris (FR); Brian Kahn, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/020,150

(22) Filed: Dec. 18, 2001

(51) Int. Cl. G06F 15/173

(52) U.S. Cl. 709/226

(57) ABSTRACT

A network-based service provider architecture. The architecture of the service provider may include a cell based stacked architecture. The network-based service provider architecture may include a plurality of cells hosting a multi-tiered application environment and a common logical network layer. The common logical network layer may provide network connectivity and enforce individual access policy of each cell of the plurality of cells, where each cell is connected to the common logical network layer.

### FIELD OF THE INVENTION

The invention is generally related to network-based service provider infrastructure. More particularly, the invention is related to a network infrastructure.

### BACKGROUND OF THE INVENTION

The number of service providers and services available on networks has grown considerably in recent years. Service providers on networks, for example, the Internet, may provide increasingly complex services to users or customers, from informational web sites to e-commerce. As services become more complex, the need to provide more customized applications for each customer also grows. For example, enterprise utilities may require half of its applications to be customized for each customer while on-tap utilities, such as messaging on tap services, may not need to customize any of its applications. A service provider providing a large percentage of customized applications needs to reflect the high level of customization of its applications in its network architecture. There is a need for service provider infrastructure that meets this variety of needs while being flexible, scalable and secure, and thus, cost effective.

One approach to service provider site architecture has been a traditional cascaded architecture. In this approach, each user environment may be connected to the core distribution layer of the service provider site. Network hardware may be dedicated for each customer or service option. Inside each user environment, a front-end tier is connected to the application tier and the application tier is connected to the data tier, the tiers partitioned internally by firewall boundaries. The use of firewalls between parts of the service provider site requires many different access ports and criteria in the firewalls, increasing the possibility of error and reducing the effectiveness of security for the site.

In order to optimize traffic flow to the back end, dual-homed web servers may be used as the front end tier. In this approach, one leg of a web server is linked to the public side of a customer environment and another leg of the web server is linked to the private side. This means significant additional configuration must be put in place on each server, including static route information.

This architecture may be problematic when changes occur, such as adding a new type of application or service that does not follow the existing pattern. When such changes in the user environment occur, a new environment has to be built in parallel to the existing environment, resulting in added implementation time.

Another approach using the cascaded architecture may include two front end tiers connected to the same back end tier. This approach attempts to leverage database resources across multiple customers or services. However, the backend firewall may not scale appropriately using this approach due to physical limitations and cost. The front end common logical network layer and switches may need to be administered in a separate data flow, resulting in additional complexity and, therefore, decreasing overall security.

There may also be a need to implement out of band third party connections, such as, for example, a connection to a third party to perform credit card validations. The back end tier may be directly connected to the third party providing remote applications. Such connections, which are common in web hosting environments, are typically too complex to place in a cascaded environment or a distributed environment, where different tiers are located in different geographic locations.

### SUMMARY OF THE INVENTION

A network-based service provider architecture is described. The architecture of the service provider may include a cell based stacked architecture. The network-based service provider architecture may include a plurality of cells hosting a multi-tiered application environment and a common logical network layer. The common logical network layer may provide network connectivity and enforce individual access policy of each cell of the plurality of cells, where each cell is connected to the common logical network layer.

### BRIEF DESCRIPTION OF THE DRAWINGS

The invention is illustrated by way of example and not limitation in the accompanying figures in which like numeral references refer to like elements, and wherein:

FIG. 1 is a network diagram illustrating an exemplary embodiment of a network including a service provider site according to principles of the present invention;

FIG. 2 is a block diagram illustrating one embodiment of the service provider site architecture of FIG. 1;

FIG. 3 is a network diagram illustrating one embodiment of the service provider site of FIG. 1;

FIG. 4 is a network diagram illustrating one embodiment of the flow of data through a service provider site of FIG. 3; and

FIG. 5 is a flow chart illustrating one embodiment of a method for flexible, scalable service through a service provider site.

### DETAILED DESCRIPTION OF THE INVENTION

In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to obscure unnecessarily the invention.

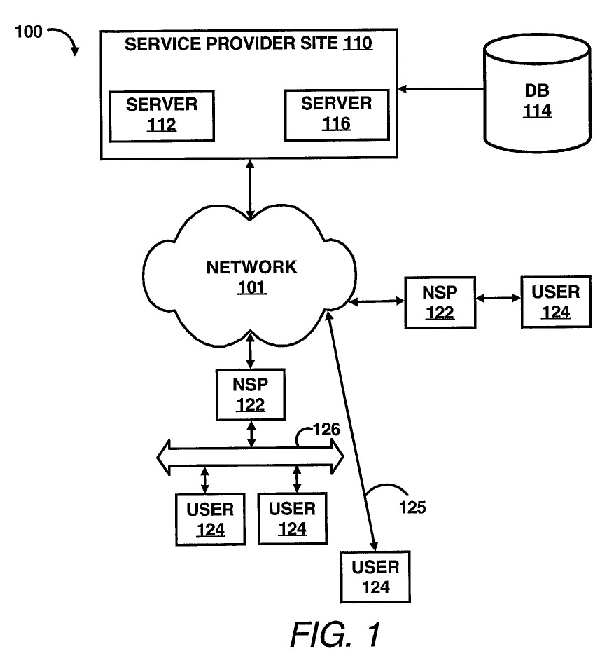

FIG. 1 is a network diagram illustrating an exemplary embodiment of a network including a service provider site (“SP”) 110 according to principles of the present invention. This system 100 includes a SP site 110, network 101 and network service providers 122.

The network 101 may include the internet or any other network such as a local area network (“LAN”), a wide area network (“WAN”), etc. The SP site 110 may include a server 112 for serving pages, such as, for example, web pages, to users of network 101. The server 112 may include, for example, a workstation running a Microsoft Windows™ NT™ operating system, a Windows™ 2000 operating system, a Unix operating system, etc. The SP site 110 may also be connected to a database 114.

Although the database is shown outside the SP site 110, one embodiment, the database 114 maybe included with the SP site 110. The database 114 may be, include or interface to, for example, an Oracle™ relational database, an Informix™ database, etc. The database may be supported by a server or other resources, and may include redundancy, such as a redundant array of independent disks (RAID), for data protection.

Network service providers (“NSPs”) 122 may provide communications between user systems 124 and network 101. The users 124 maybe connected to network 101 through network service provider 122. In one embodiment, users 124 maybe connected to network service provider 122 through another network 126. Network service providers 122 and SP site 110 may be connected to the network 101 through a communications link. In one embodiment, a user 124 may be connected to a network 101 through a communications link 125. In one embodiment the network 101 may be or include a communications link 125.

User(s) 124 may be or include a client system. The user(s) 124 may include, for example, a personal computer running a Microsoft Windows™ 95 operating system, a Windows 98 operating system, a Millenium™ operating system, etc. The user(s) 124 may also include a network-enabled appliance such as a WebTV™ unit, a radio-enabled Palm™ Pilot or a similar unit, a set-top box, etc.

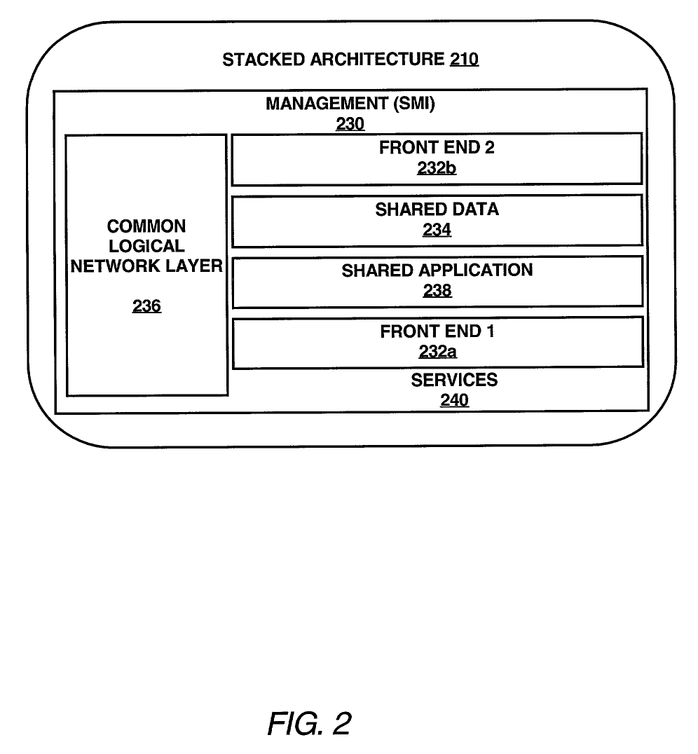

FIG. 2 is a block diagram illustrating one embodiment of the SP site 110 of FIG. 1. FIG. 2 highlights the security features of the invention. The SP site 210 may have a stacked architecture using a “cell” concept. Cells may include a group of servers or devices that share the same network infrastructure, network address space and access policy. The network address space may include internet protocol (“IP”) space.

The SP site 210 may include a plurality of cells 230, 232a, 232b, 234, 238, 240 that host a multi-tiered application environment, where each cell 230, 232a, 232b, 234, 238, 240 is connected to a common logical network layer 236. A multi-tiered application may include any function or service that uses resources from more than one cell 230, 232a, 232b, 234, 238, 240. For example, a multi-tiered application may include a web server front-end cell 232a, 232b delivering content from a database back-end 234.

Each of the cells 230, 232a, 232b, 234, 238, 240 may contain one or more servers or devices that share network address space and access policy. Access policy may include the rules and mechanisms controlling the flow of data in and out of each cell. For example, access policy may include traditional access control policy, such as authentication, authorization, and access enforcement. Access policy may also include other access type characteristics, such as, privacy protections and/or integrity guarantees. Privacy protections may include virtual private networks (“VPNs”). Integrity guarantees may include, for example, integrity guarantees of IPv6.

The common logical network layer 236 may include several physical network components connected together. The common logical network layer 236 may provide network connectivity and enforce the cell's individual access policy. The common logical network layer 236 may be connected to the network 101, a telecommunications infrastructure, or other distribution arrangements. The network connectivity function, of the common logical network layer 236, may include local area network (“LAN”) and/or wide area network (“WAN”) functions, connecting cells which are geographically distant from each other. The network connectivity function may also include connecting cells with private user networks or public networks, such as the Internet. The common logical network layer 236 may provide routing and transmission functions for data services.

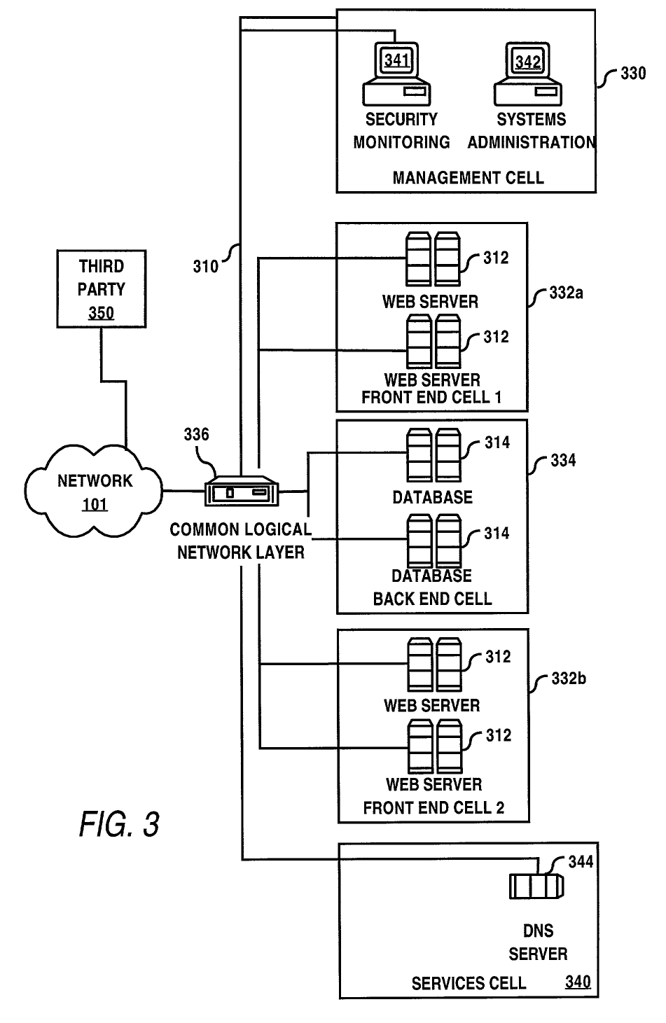

In the example of a network-based service provider, the stacked architecture may include at least one front end cell 232a, 232b and a back-end or shared data cell 234. In one embodiment, the cells may also include a management cell 230, a shared application cell 238 and a services cell 240 The cells 230, 232a, 232b, 234 and 240 will be described in more detail below, with respect to FIG. 3. The shared application cell 238 may include an application that may be shared by users of the SP site 210.

In one embodiment, a specific network security policy, such as access control lists, may apply to each type of cell. Inter-cell communication may be possible (e.g., front end cell to data cell or web tier to data tier), but may be restricted to specific protocols. The simplicity of the stacked architecture makes risk management easier to implement and manage. Easier implementation of risk management makes network security configuration less error-prone, and as a result, increases overall infrastructure security.

Because of the stacked design of the SP site 210, application cells 238, data cells 234, and front end cells 232a, 232b may be added or deleted from the SP site 210 without impacting the existing cells. New services may be added and existing services may be expanded without redesigning the customer environment. Thus, implementation time for the service provider is reduced, and flexibility for providing service is increased.

An additional gain is made in scalability because of the sharing of the network resources, such as common logical network layer 236, management cell 230, front end cell 232a, 232b, and data cell 234. Scalability is also enhanced by the simplified wiring and simplified server setup of the stacked architecture.

FIG. 3 is a network diagram illustrating one embodiment of the SP site 110 of FIG. 1. SP site 310 is coupled to network 101, which may be coupled to a third party site 350.

In the embodiment shown by FIG. 3, management cell 330, front end cell1 332a, back end cell 334, front end cell2 332b and services cell 340 are all connected to network 101 through common logical network layer 336. In one embodiment, the common logical network layer 236 comprises a firewall router. The core distribution layer 236 or common logical network layer 336 provides a connection for inter-cell communication as well as communication to outside entities, e.g., network 101. Outside entities may include the public internet, a customer corporate network, a management network, etc.

In the embodiment shown by FIG. 3, front end cells 332a, 332b may include one or more web servers 312. The web servers 312 may be shared by all users. In one embodiment, a front end cell 332a, 332b dedicated to a high end user may be created and/or added to SP site 310. Although two front end cells 332a, 332b are shown, in practice as few as one front end cell 332a, 332b or more than two front end cell 332a, 332b may be used, depending on design or requirements of the SP site 310.

The back end cell 334 may include one or more databases 314. In one embodiment, a database 314 may include an exchange server. The back end cell 334 may be shared by all users. Even if a front end cell 332a, 332b dedicated to a high end user is added, the shared back end cell 334 may still be used by the high end user for its exchange server. Thus, the additional front end cell 332a, 332b may be added to the SP site 310 without much disruption or impact to the existing environment.

The management cell 330 may include the SP site's 310 management functions. In one embodiment, the management cell 330 may include at least one of a security monitoring component 341 and a systems administration component 342.

The services cell 340 may provide support services for the SP site 310. In one embodiment, the services cell 340 may include a domain name system (“DNS”) server 344, such as a SMTP server or mail gateway.

In the embodiment shown in FIG. 3, the web front end servers 312 of front end cell1 332a may be shared by all customers, and back end exchange servers or databases 314 may be housed in a common cell 334. Using the stacked architecture, an additional front end cell 332b dedicated to a customer may be created, and still used the shared database cell 334 for its exchange server without much disruption or impact to the existing environment. For example, a high end customer may require high performance. Thus, front end cell2 332b may be dedicated to the high end customer although the high end customer would still use back end cell 334.

The stacked architecture approach to the SP site 310 allows for a geographically distributed environment for a specific application or service without impacting the design or compromising the security of the SP site 310. For example, Thus a front cell 332a, 332b or a web server 312 of the front end cell 332a, 332b may be in a first data center while a back end cell 334 or a database 314 of the back end cell 334 is in a second data center, where the first data center and the second data center are in geographically diverse locations. Thus, the common logical network layer 336 may connect cells 330, 332a, 332b, 334, 340 that are geographically distant, providing wide area network functions.

The third party site 350 may be a third party service provider executing remote applications such as, for example, credit card validations. The implementation of a direct connection between the third party 350 and a database 314 of a back end cell 334 is greatly simplified. The third party may be coupled to network 101 and exchange data with a database 314 of a SP site 310 without being routed through the web servers 312, and without requiring an additional direct connection to avoid being routed through the web servers 312.

The service provider architecture also provides support infrastructure to host multiple customers, including the service provider's added-value functions. For example, the added-value functions may include a mail gateway in the services cell 340 and/or security monitoring functions in the management cell 330. Thus, the stacked architecture offers increased service flexibility.

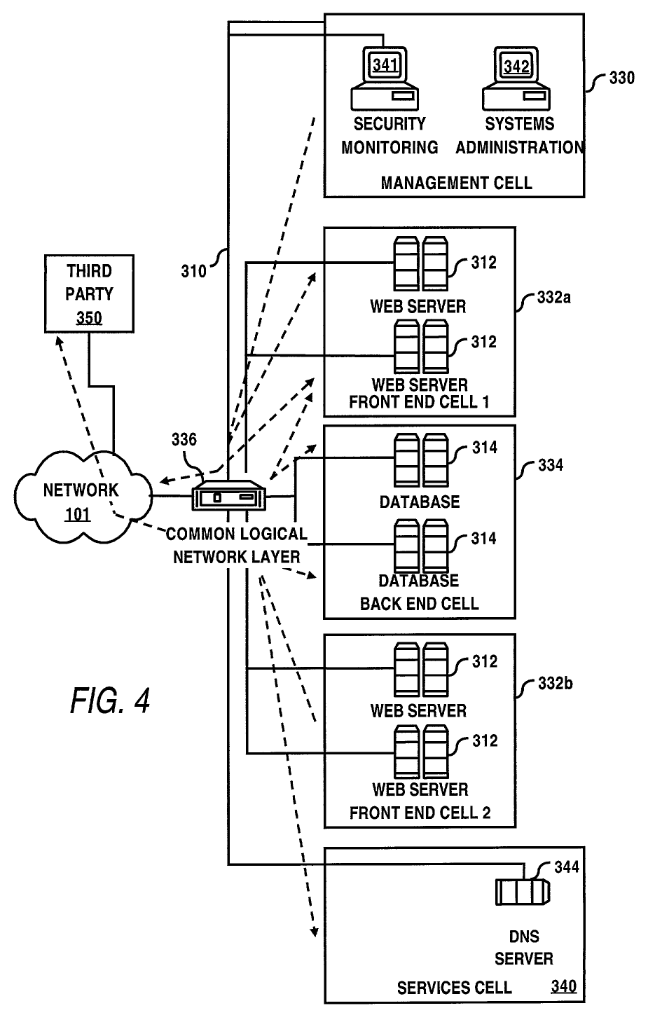

FIG. 4 is a network diagram illustrating one embodiment of the flow of data in the SP site 310 of FIG. 3. The arrows illustrate exemplary movement of data through SP site 310. A common logical network layer 336 may receive data from a cell of the SP site 310 or network 101. The router 336 may receive data from any one of the management cell 330, front end cells 332a, 332b, back end cell 334 and services cell 338.

The common logical network layer 336 may route the data received to a cell 330, 332a, 332b, 334, 340 of the SP site 310 or the network 101. In one embodiment, the router 336 may route the received data based on routing information in the data. The data may include text, image, or any other type of data that may be used in the performance of SP site 310. As shown by the arrows, data may flow directly from a third party site 330 to a back end cell 334 through common logical network layer 336. Data may flow between network 101 and a web server 312 of front end cell 332a, from a secure management cell 330 to a front end cell 332a, between a front end cell 332a to a back end cell 334, and from a front end cell 332b to a services cell 340, all through common logical network layer 336.

In one embodiment, a designated user may be a high end user with a dedicated web server 312 or a dedicated front end cell 332b. If the common logical network layer 336 receives data associated with or directed to the designated user, the common logical network layer 336 may direct the data to the dedicated web server 312 or the dedicated front end cell 332b, if the routing information indicates it should be routed to a web server. Although the shared back end 334 cell is used for back end functions of the high end user, the flow of data through the common logical network layer 336 allows a front end cell 332b dedicated to one user to be used in SP site 310. Thus, additional front end cells 332b may be easily built and added to the SP site 310, by connecting each additional front end cell 332b with the common logical network layer 336.

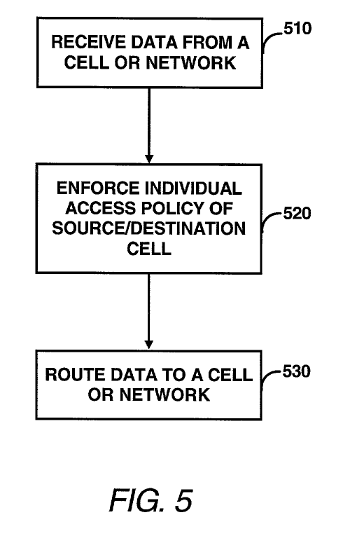

FIG. 5 is a flow chart illustrating one embodiment of a method for providing service using the stacked architecture approach of the present invention. The method will be described with reference to FIG. 3. At processing block 510, a common logical network layer 336 may receive data from a cell 330, 332a, 332b, 334,338 of the SP site 310 or network 101. If the data is received from a cell, the common logical network layer 336 may receive data from any one of the management cell 330, front end cells 332a, 332b, back end cell 334 and services cell 338.

At processing block 520, the common logical network layer 336 enforces the individual access policy of the destination cell of the data, if the data is directed to a cell 330, 332a, 332b, 334, 338 or the source cell of the data, if the data is received from a cell 330, 332a, 332b, 334, 338. If the data is received from one of the cells 330, 332a, 332b, 334, 338 and directed to another of the cells 330, 332a, 332b, 334, 338, the common logical network layer 336 may enforce the individual access policies of both the source cell and the destination cell.

At processing block 530, the common logical network layer 336 may transmit the data received at processing block 510 to a cell 330, 332a, 332b, 334, 338 of the SP site 310 or the network 101. In one embodiment, the common logical network layer 336 may route the received data based on routing information in the data. The data may include text, image, or any other type of data that may be used in the performance of the services of SP site 310.

The stacked architecture described with reference to FIGS. 2, 3 and 4 provides service flexibility, scalability and security. As described above, with reference to FIG. 3, the stacked architecture provides increased service flexibility. The scalability is also improved since network infrastructure equipment may be shared by all customers, making it a more cost effective use of the investment in the equipment.

The stacked architecture also simplifies wiring, and offers more flexibility for rack configuration, i.e., configuration of the boxes housing computers for use in the operation of SP site 310, and configuration of the computers housed. The stacked configuration requires fewer cross connects between the racks. This may result in savings in datacenter floor space and costs.

The stacked architecture also supports the use of single-homed web servers with only default route to configure per server, as opposed to the dual-homed web servers that were supported by the cascaded architecture. As the datacenter grows, this parameter does not increase since all devices in each cell are connected through only one logical network layer device 336. Thus, the addition of more servers 312 is supported in the stacked architecture since each server 312 needs only to be connected to the logical network device 336.

Security is also improved, as described above with reference to FIG. 2. One access control, common logical network layer 336, for the group of devices (i.e. each cell 330, 332a, 332b, 334, 340) allows for a less error-prone system. Lowering error, and thus increasing security, lowers the cost of ownership of the SP site 310.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

what is claimed is:

1. A network-based service provider architecture, comprising:
a plurality of cells hosting a multi-tiered application environment; and
a common logical network layer providing network connectivity and enforcing individual access policy of each cell of the plurality of cells, wherein each cell is connected to the common logical network layer.

2. The architecture of claim 1, wherein each cell comprises one or more servers or devices, the one or more servers or devices sharing network address space and access policy.

3. The architecture of claim 1 wherein access policy comprises rules and mechanisms controlling the flow of data in and out of each cell.

4. The architecture of claim 1 wherein access policy comprises at least one of authentication, authorization, access enforcement, privacy protections and integrity guarantees.

5. The architecture of claim 1 wherein the network connectivity comprises at least one of a local area network function and a wide area network function, wherein the common logical network layer connects cells which are geographically distant from each other.

6. The architecture of claim 1 wherein the network connectivity comprises connecting cells with at least one of private user networks and the Internet.

7. The architecture of claim 1 wherein the multi-tiered application comprises any function or service that uses resources from more than one cell.

8. The architecture of claim 1, wherein the multi-tiered application environment comprises infrastructure to host multiple users.

9. The architecture of claim 1 wherein the cells of the multi-tiered application environment comprise at least one of added value functions, system administration functions and security monitoring functions.

10. The architecture of claim 1, wherein the plurality of cells comprises at least one front end cell and a back end cell, the front end cell including a web server front-end delivering content and the back end cell including a database back-end.

11. The architecture of claim 10, wherein the front end cell comprises at least two front end cells including a first front end cell and a second front end cell, wherein access to the first front end cell is shared by all users of the network-based service and access to the second front end cell is limited to a designated user of the network-based service.

12. A method for providing a network-based service, comprising:
receiving data in a common logical network layer from at least one of a cell of a plurality of cells of a multi-tiered application and a network;
enforcing access policy of a destination cell of the plurality of cells to which the data is directed, if the data is directed to a cell of the plurality of cells;
enforcing access policy of a source cell of the plurality of cells, if the data is received from a cell of the plurality of cells;
transmitting the data to at least one of the destination cell and the network.

13. The method of claim 12, wherein enforcing access policy comprises enforcing rules and mechanisms controlling the flow of data in and out of at least one of the source cell and destination cell.

14. The method of claim 12, wherein enforcing access policy comprises performing at least one of authentication, authorization, access enforcement, privacy protections, and integrity guarantees.

15. The method of claim 12, wherein each cell of the plurality of cells comprises one or more servers or devices, the one or more servers or devices sharing network address space and access policy.
